(19) United States
(12) Patent Application Publication
(10) Pub. No.: US 2004/0205657 A1
(43) Pub. Date: Oct. 14, 2004

(54) Method and system for linking project information

(75) Inventors: Yutaka Kudo, Yokohama (JP); Kenichi Koto, Ichikawa (JP); Chiaki Hirai, Tokyo (JP); Kenichi Matsuo, Yokohama (JP); Takeki Fujinami, Yokohama (JP)

Correspondence Address: McDermott, Will & Emery, 600, 13th Street, N.W., Washington, DC, 20005-3096, US

(73) Assignee: Hitachi, Ltd.

(21) Appl. No.: 10/066,584

(22) Filed: Feb. 6, 2002

(30) Foreign Application Priority Data
Nov. 15, 2001 (JP) 2001-349564

(51) Int. Cl. G06F 17/24

(52) U.S. Cl. 715/530; 715/501.1

(57) ABSTRACT

The present invention provides a data linking method, for use in design development work, that solves the problem of the need to re-enter data or of a delay in reflecting data that may occur when a progress management unit, a review management unit, and a pending issue management unit for work items perform operation independently. The method according to the present invention creates a review report template including review items defined by a review report management system and pending issues registered with a pending issue management system, extracts pending issues and approved information from a review report created based on the review report template, registers the extracted pending issues and information with the pending issue management system, calculates a solution status and a discussion status of the document from the review report, and registers the calculated status with an work item management system.

### BACKGROUND OF THE INVENTION

The present invention relates to a review report management method and a pending issue management method for use in a development project of software and so on and a progress management method for work items, and to a recording medium recording thereon a program that executes the method on a computer.

Design and development work, for example, software design and development, is done by repeating the following steps: check the progress in work items, do design work (create design documents), hold a review meeting for reviewing documents, and manage the pending issues of documents. For example, when the basic design work is completed and, after that, the functional design work is started, whether or not the basic design work has been completed is examined by checking the progress. Until the basic design work is completed, the document of the basic design is reviewed as necessary and problems, if any, are managed as pending issues. The pending issues pointed out during the review are used as new progress data, which is then used to check the next progress. A document creator reflects the solutions to the pending issues on the design document and receives the review again.

Conventionally, progress management means, review management means, and pending issue management means have been separately provided and used.

JP-A-10-240797 discloses a process management aid system capable of registering pending issues with a document and managing the solution status.

JP-A-2000-172702 discloses a method that allows the user to define a review item system of design-time check items for the entire development work and, from the registered review report, calculates the review item coverage degree to display the project progress.

In addition, JP-A-2000-200308 discloses a method that defines a work breakdown structure (WBS) and, according to the WBS, displays progress data being managed.

However, separately operating the progress management means, review management means, and pending issue management means creates the following problems.

First, to make a review meeting proceed smoothly, the user sometimes wants to reference, during the meeting, the pending issues of a particular document that were outstanding at the previous review time and whether or not those issues have been solved. In this case, the review materials containing the pending issues, their solutions, and their solution status must be manually prepared with the use of the pending issue management means. In addition, the user sometimes wants to define review items for a particular document and to attend a review meeting while referencing those review items. In this case, too, the review materials containing the review items must be created manually with the use of the review report management means.

Another problem is that, when creating a review report after completing a review meeting, the review items as well as the pending issues that were outstanding at the previous review time must be copied manually with the use of the review report management system and the pending issue management system to create a review report. Furthermore, if pending issues develop as a result of review, the pending issue management system must be used after the review to manually register the pending issues that have developed. If the pending issues are solved, there exists a problem that the project manager must use the pending issue management system after the review to manually change the status of the solved pending issues to “Completed”.

Still another problem is that, even if the project manager attended a review meeting and approved solutions to a pending issue, the project manager must use the pending issue management system after the review meeting to manually change the status of an approved pending issue to “Approved”. Furthermore, to allow the work item management system to reference the progress status data concerning a particular document, the progress status data must be copied manually to the work item management system. In addition, to allow the work item management system to reference the discussion status concerning a particular document, the discussion status data must copied manually to the work item management system.

### SUMMARY OF THE INVENTION

It is an object of the present invention to provide a method for linking data among management means for solving the above-described problems that could develop when the work item progress management means, review management means, and pending issue management means are run independently and for solving the problem of a need for the user to intervene and a delay in reflecting information.

To achieve the above object, the system according to the present invention comprises a review report template creation unit that has a table containing the relation between documents to be reviewed and review items and that generates a review report template including the review items for a document to be reviewed as well as the pending issues and the solution status related to the document to be reviewed.

The system also comprises a pending issue extraction and registration unit that extracts pending issues and approval information from a review report created based on a review report template, creates data to be passed to pending issue management means, and registers the data the means.

The system also comprises an index registration unit that calculates the solution status and the discussion status of pending issues for the document from the contents of the review report and that registers the calculated status with a work item management system.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the functional blocks of a project information linking method in an embodiment of the present invention.

FIG. 2 is a diagram showing an example of a work item tree 132 provided in a work item management system 131.

FIG. 3 is a diagram showing an example of a review item tree 122 provided in a review report management system 121.

FIG. 4 is a diagram showing an example of a document/review-item relation definition 109 provided in a project information linking system 101.

FIG. 5 is a diagram showing an example of pending issue data 142.

FIG. 6 is a diagram showing an example of review report data 123.

FIG. 7 is a diagram showing an example of data format conversion table 111.

FIG. 8 is a flowchart showing the processing flow of a review report template creation unit 105.

FIG. 9 is a flowchart showing the processing flow of a pending issue extraction and registration unit 110.

FIG. 10 is a flowchart showing the processing flow of an index registration unit 102.

### DESCRIPTION OF THE EMBODIMENT

An embodiment of a project information linking method according to the present invention will be described in detail with reference to the drawings.

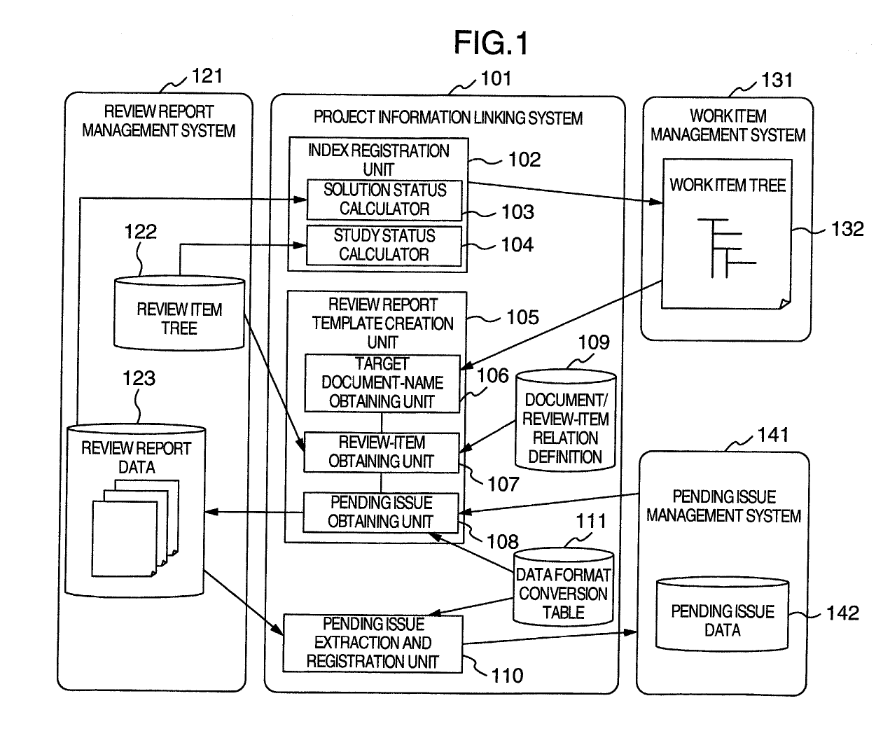

FIG. 1 is a diagram showing an example of the functional blocks used by the project information linking method in the embodiment of the present invention. Referring to FIG. 1, a project information linking system 101 is connected to a review report management system 121, a work item management system 131, and a pending issue management system 141 for transferring data to or from those systems.

The above systems 101, 121, and 131 are computers, each with input devices such as a keyboard and a mouse, output devices such as a display and a printer, and external storage devices such as a hard disk. They are interconnected over a network.

The review report management system 121 has a review item tree 122, which has a tree structure format and defines the items to be discussed from project start to project end, and a plurality of units of review report data 123.

The work item management system 131 has a work item tree 132 that defines, in a tree structure, the work items to be carried out from project start to project end.

The pending issue management system 141 has pending issue data 142 generated from project start to project end.

The project information linking system 101 has a review report template creation unit 105 that creates the template of a review report. This unit obtains a user-specified document name from the work item tree 132 (target document-name obtaining unit 106), extracts and obtains review items, related to the document name, from the review item tree 122 based on a document/review-item relation definition 109 (review-item obtaining unit 107), and obtains pending issue data 142, related to the document name, from the pending issue management system 141 for conversion to a review report data format based on a data format conversion table 111 (pending issue obtaining unit 108).

The project information linking system 101 also has a pending issue extraction and registration unit 110. When a review report is registered, this unit extracts pending issues from the contents of the review report, converts the format of the extracted contents to a data format that can be registered with the pending issue management system 141 based on the data format conversion table 111, and registers data with, or updates data of, the pending issue management system.

The project information linking system 101 also has an index registration unit 102. This unit calculates a pending-issue solution status and a review discussion ratio from the contents of a registered review report (solution status calculator 103, discussion status calculator 104) and registers the calculated results with the work item tree 132 in the work item management system 131.

The detailed processing procedures performed by the review report template creation unit 105, pending issue extraction and registration unit 110, and index registration unit 102 and the detailed data structure of the review item tree 122, review report data 123, document/review-item relation definition 109, data format conversion table 111, work item tree 132, and pending issue data 142 will be described later.

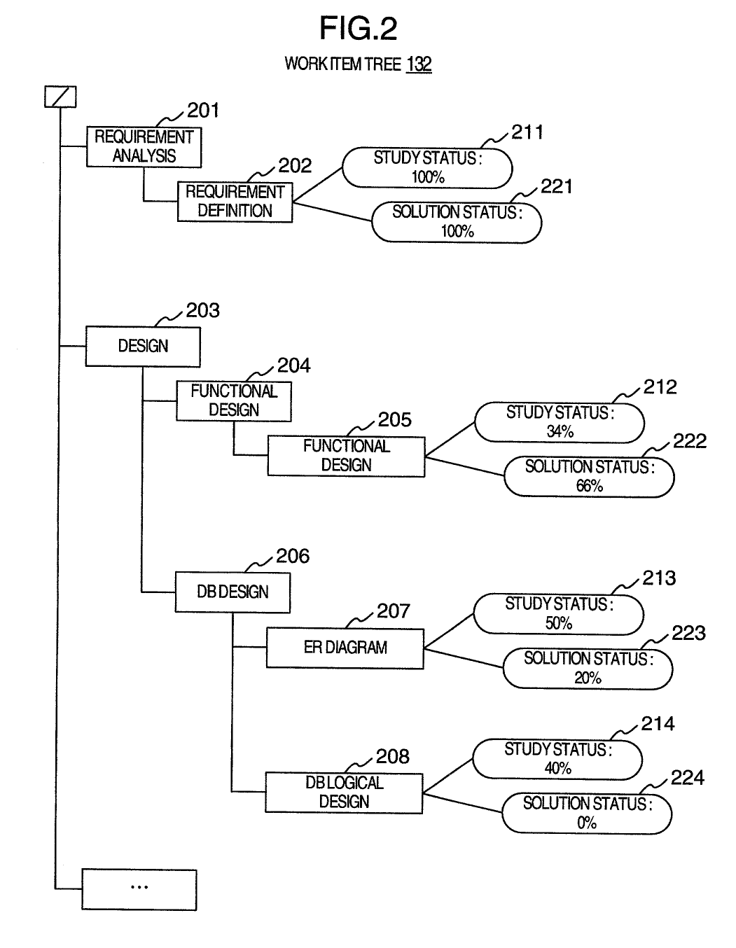

FIG. 2 shows an example of the data structure of the work item tree 132 provided in the work item management system 131. As shown in the figure, the work item tree 132 is composed of work items 201-208 arranged in a tree structure. At each end element (202, 205, 207, 208) of the tree, a document name is described to indicate that a document is created as the result of the work. In addition, each end element may have two types of attributes: discussion (study) status 211-214 of the end element and solution status 221-224 of the pending issue. For example, the value of the discussion status 213 indicates that the discussion status of the work item 207, “ER diagram”, is 50%. Similarly, the value of the solution status 223 indicates that the solution status is 20%. The calculation method for the discussion status and the solution status will be described later.

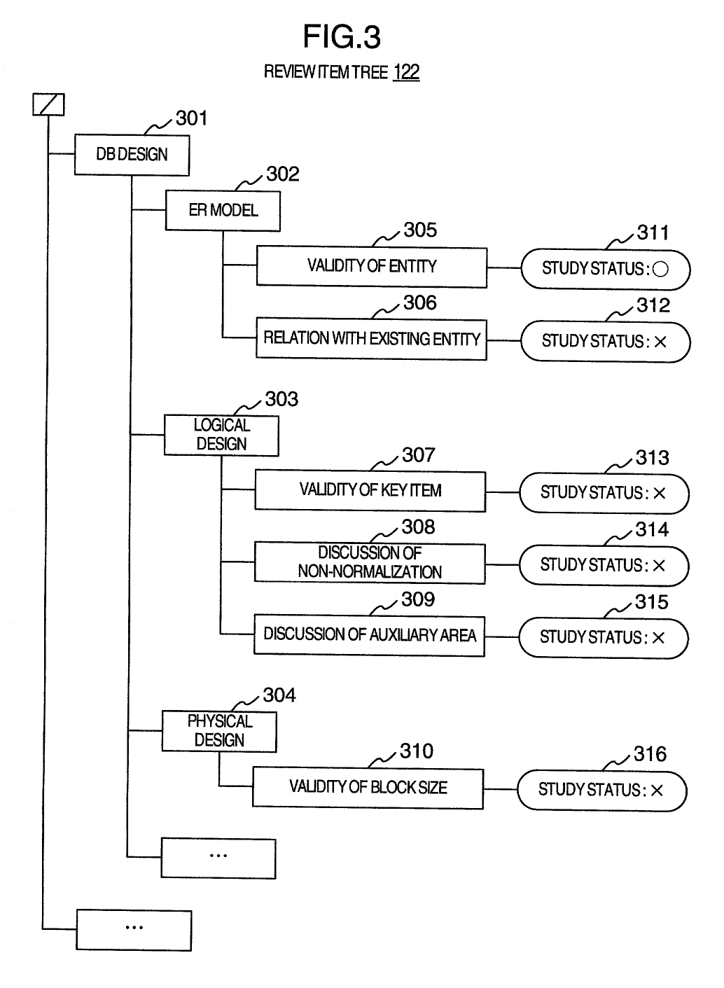

FIG. 3 shows an example of the data structure of the review item tree 122 provided in the review report management system 121. The review item tree 122 is composed of review items 301-310 arranged in a tree structure as shown in the figure. Each end element (305-310) may have the discussion status 311-316 of the review item of each end element as its attribute. The discussion status, which is represented by symbols “◯” and “X”, indicates whether or not the corresponding review item is present in the review report data 123. The symbol “◯” indicates that the review item is present in the review report data 123, while the symbol “X” indicates that the review item is not. That is, the symbol “◯” indicates that the meeting was held.

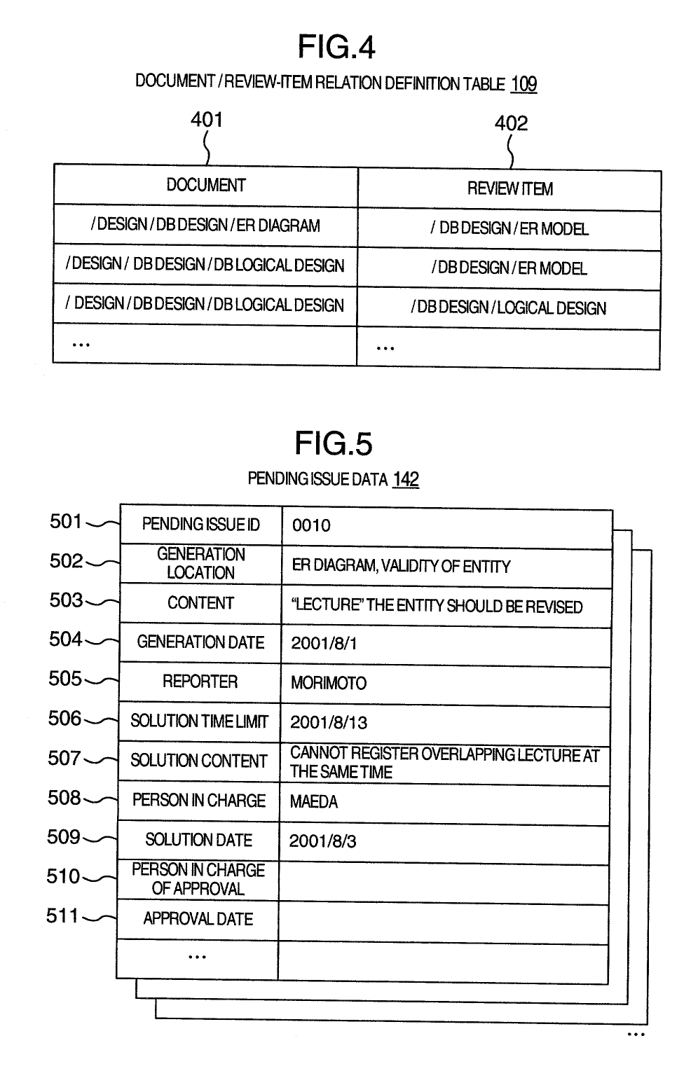

FIG. 4 shows an example of the data structure of the document/review-item relation definition 109 provided in the project information linking system 101. The document/review-item relation definition 109, which defines the relation between documents and review items, is composed of a document 401 and a review item 402. The document 401 identifies a document in the work item tree 132 shown in FIG. 2, while the review item 402 identifies a review item in the review item tree 122 shown in FIG. 3.

Each value of the document 401 and the review item 402, represented as the full path format of an element in the tree structure, is a parent-child relation among elements with the “/” symbol as the delimiter. For example, when the value of the document 401 is “/Design/DB design/ER diagram”, it indicates that the child element of “Design” is “DB design” and that the child element of “DB design” is “ER diagram”. “/Design/DB design/ER diagram” represents three items in FIG. 2—203, 206, and 207—as one character string. Similarly, when the review item 402 is “/DB design/ER model”, it represents two items in FIG. 3—301 and 302.

The sample definition in the first row in the document/review-item relation definition 109 in FIG. 4 indicates that “/Design/DB design/ER diagram” and “/DB design/ER model” are related. That is, when discussing the document named ER Diagram at a meeting, this definition says that the review items of the ER model, that is, “Validity of entity” (305 in FIG. 3) and “Relation with existing entity” (306 in FIG. 3), should be discussed.

FIG. 5 shows an example of the data structure of the pending issue data 142. Each pending issue has one unit of data in FIG. 5, and the external storage device provided in the work item management system 131 is assumed to be able to store a plurality of units of pending issue data 142. One unit of pending issue data 142 is composed of a pending issue ID 501 that uniquely identifies one unit of pending issue data, a generation location 502 that identifies a document or a program to be used as a pending issue, a content 503 that contains the content of the pending issue, a generation date 504 that contains the date on which the pending issue became outstanding, a reporter 505 that contains the name of the user who registered the pending issue with the pending issue management system, a solution time limit 506 that contains the solution time limit for the pending issue, a solution content 507 that contains a solution method for the pending issue, a person in charge 508 that contains the user who has solved the pending issue, a solution date 509 that contains the date on which the pending issue was solved, a person in charge of approval 510 that contains the name of the user who approved the solution content 507, and an approval date 511 that contains the date on which the solution content 507 were approved.

The pending issue ID 501 is assigned by the pending issue management system 141 when pending item data is registered. When the pending issue is unresolved or unapproved, the items 506-511 may contain blanks.

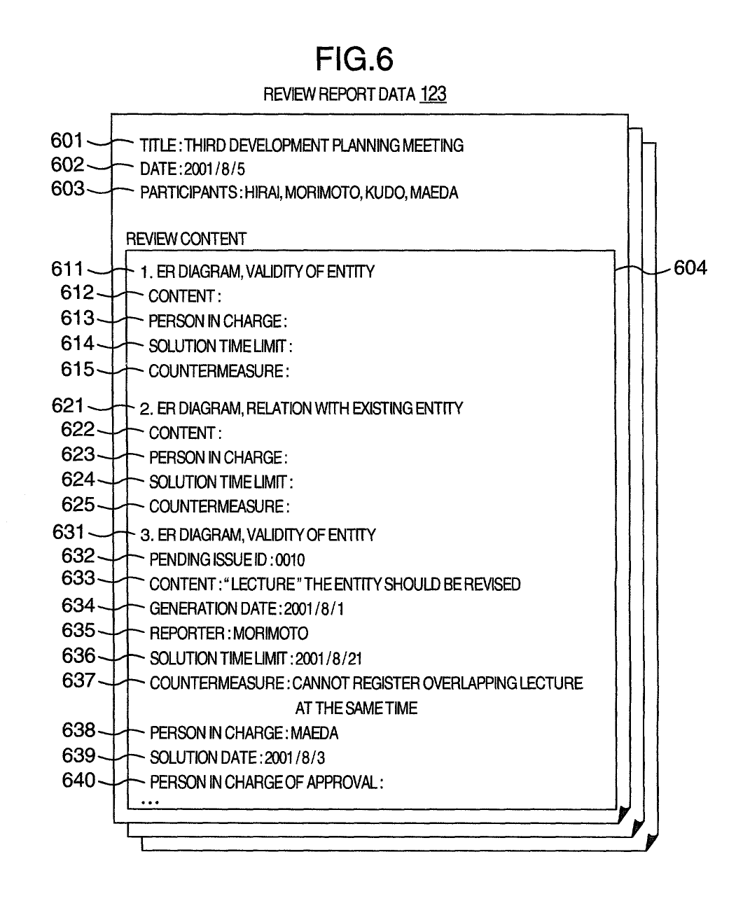

FIG. 6 shows an example of the data structure of the review report data 123. The external storage device of the review report management system is assumed to be able to contain a plurality of units of review report data 123. One unit of review report data 123 is composed of a title 601 that contains the name of a meeting, a date 602 that contains the date on which the meeting was held, a participant 603 that contains the names of participants in the meeting, and a review content 604 that contains the review content. The review content 604 is composed of a plurality of paragraphs 605-607 each containing one subject.

The paragraphs 605 and 606 are created by the review-item obtaining unit 107 of the project information linking system 101. In the example, the user has not yet entered review contents into those paragraphs. In this case, one paragraph is composed of a header character string (611, 621) indicating the header of the subject, content (612, 622) into which a pending issue pointed out at the meeting will be entered, a person in charge (613, 623) indicating the name of a worker who is assigned to solve the pending issue, a solution time limit (614, 624) of the pending issue, and a countermeasure (615, 625) indicating the content of discussion if the issue was discussed at the meeting.

A paragraph 607 is created by the pending issue obtaining unit 108 of the project information linking system 101 using the pending issue data 142 stored in the pending issue management system 141. In this case, one paragraph is composed of a character string 631 indicating the header of the review, a pending issue ID 632 uniquely identifying the pending issue if the data was obtained from the pending issue management system, a content 633 indicating the content of the pending issue, a generation date 634 indicating the date on which the content 633 first became outstanding, a reporter 635 indicating a worker who registered the pending issue, a solution time limit 636 indicating the date until which a countermeasure must be taken for the pending issue, a countermeasure 637 indicating the content of a countermeasure to be taken for the content 633, a person in charge 638 indicating a worker who is or will be responsible for the content 633 or a worker who actually executed the countermeasure 637, a countermeasure date 639 on which the countermeasure 637 was executed, and a person who approved 640 indicating the name of a manager who approved the countermeasure 637.

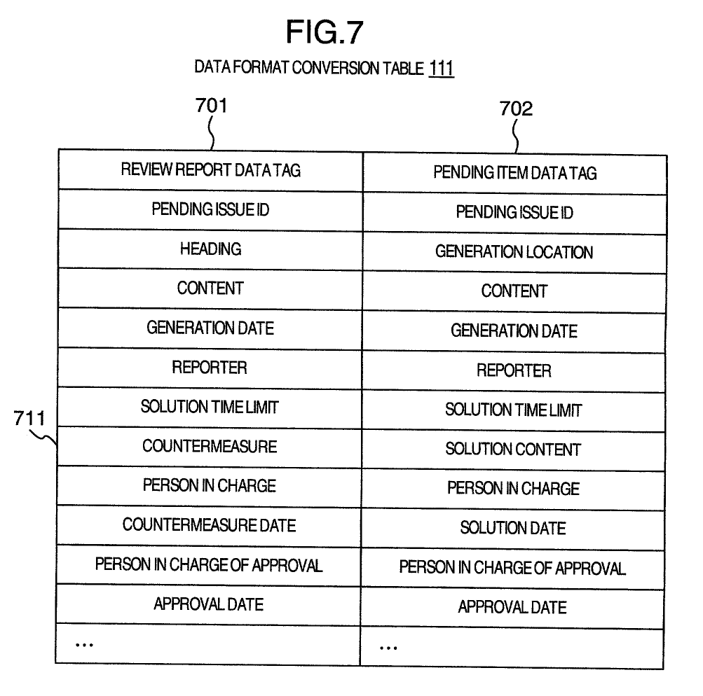

FIG. 7 shows an example of the data format conversion table 111. The data format conversion table 111 is referenced when the pending issue obtaining unit 108 of the project information linking system 101 reads the pending issue data 142 from the pending issue management system 141 to create data in a format that may be registered with the review report management system 121, that is, the review report data 123. Also, this table is referenced when the pending issue extraction and registration unit 110 of the project information linking system 101 extracts a pending item from the review report data 123 and converts it to data in a format that may be registered with the pending issue management system 141, that is, pending issue data 142.

The data format conversion table 111 is composed of review report data tags 701 and pending item data tags 702. Each row represents one correspondence. For example, a correspondence 711 in FIG. 7 indicates that a data element with the tag “Countermeasure”, if included in the review report data 123, is treated as the data element “Solution content” when creating the pending issue data 142.

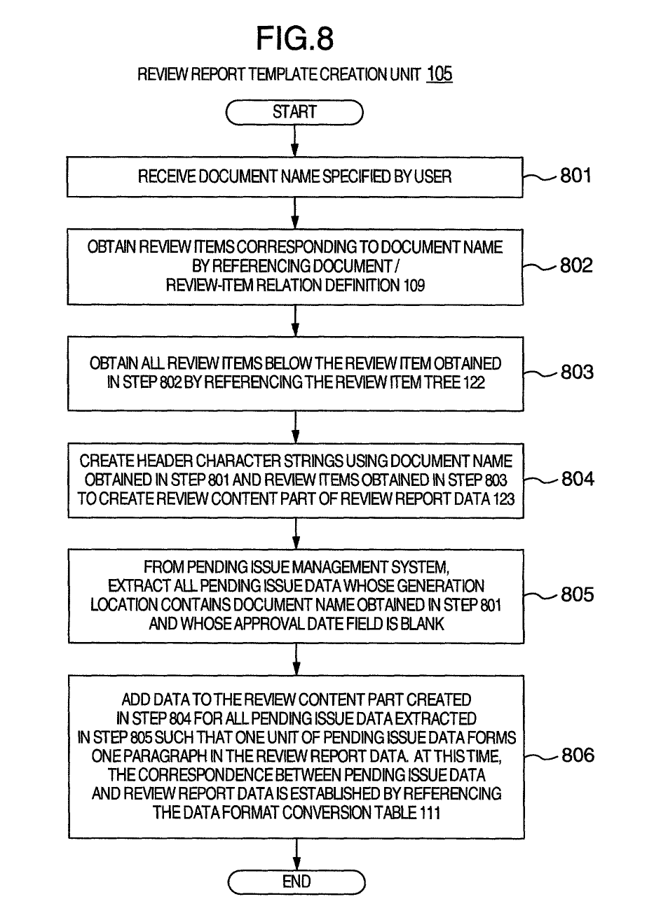

Next, with reference to the flowchart shown in FIG. 8, the following describes the processing flow of the review report template creation unit 105 that creates a review report template (review report data 123) when the user specifies a document name in the work item tree 132. Because a review report template (review report data 123) created by the review report template creation unit 105 contains the review items associated with the specified document and unresolved pending issues associated with that document, the template may be used not only as the template of the review report but also as the agenda.

First, assume that a document stored in the work item tree 132 is specified by the user and the review report template creation unit 105 is started. The target document-name obtaining unit 106 receives the user-specified document name and stores it temporarily in the memory (step 801).

Next, the review-item obtaining unit 107 references the document/review-item relation definition 109 to obtain the review items 402 from all records whose document name (401) matches the document name received in step 801 (step 802). For example, if the document is “/Design/DB design/ER diagram”, the review-item obtaining unit 107 obtains “/DB design/ER model” as the review item.

Next, the review-item obtaining unit 107 references the review item tree 122 to obtain all review items below the one obtained in step 802 (step 803). For example, if the review item obtained in step 802 is “/DB design/ER model”, all review items below this item, that is, “/DB design/ER model/Validity of entity” and “/DB design/ER model/Relation with existing entity” are obtained.

Next, the review-item obtaining unit 107 uses the (end element of) document name obtained in step 801 and the review items obtained in step 803 to create the review report content part of the review report data 123 with the review items as the headings (step 804). For example, if the review items obtained in step 803 are “/DB design/ER model/Validity of entity” and “/DB design/ER model/Relation with existing entity”, the review-item obtaining unit 107 creates the character strings “ER diagram, Validity of entity” and “ER diagram, Relation with existing entity” as the headings as shown in the example of the review report data 123 in FIG. 6 and, below each of these headings, adds the tags “Content:” (612, 622), “Person in charge: (613, 623)”, “Solution time limit: (614, 624)”, and “Countermeasure: (615, 624)” to create paragraphs. Note that the tag character strings are created for the items 612-615 and 622-625 but that their values are left blank.

In the steps to step 804, the template of the review items included in the review report content of the review report data 123 and associated with the specified document are created. In the example in FIG. 6, the paragraphs 605 and 606 are created.

Next, from the pending issue management system 141, the pending issue obtaining unit 108 extracts all units of pending issue data 142 whose generation location 502 contains the (end element of) document name obtained in step 801 and whose approval field is blank (step 805).

Next, in step 806, the pending issue obtaining unit 108 adds data to the review content part created in step 804 for all units of pending issue data 142 extracted in step 805 such that one unit of pending issue data forms one paragraph in the review report data. At this time, the pending issue data 142 is converted to the review report data 123 by referencing the data format conversion table 111. For example, because the generation location 502 is converted to “Heading” according to the data format conversion table 111 in the case of the pending issue data 142 in FIG. 5, the generation location 502 is created in the review report data 123 as the heading as shown in the character string 631 in the paragraph 607. The pending issue obtaining unit 108 processes other items 501 and 503-511 of the pending issue data 142 in the same manner to create the review content part.

The processing in steps 801-806 completes the review report data 123 shown in FIG. 6.

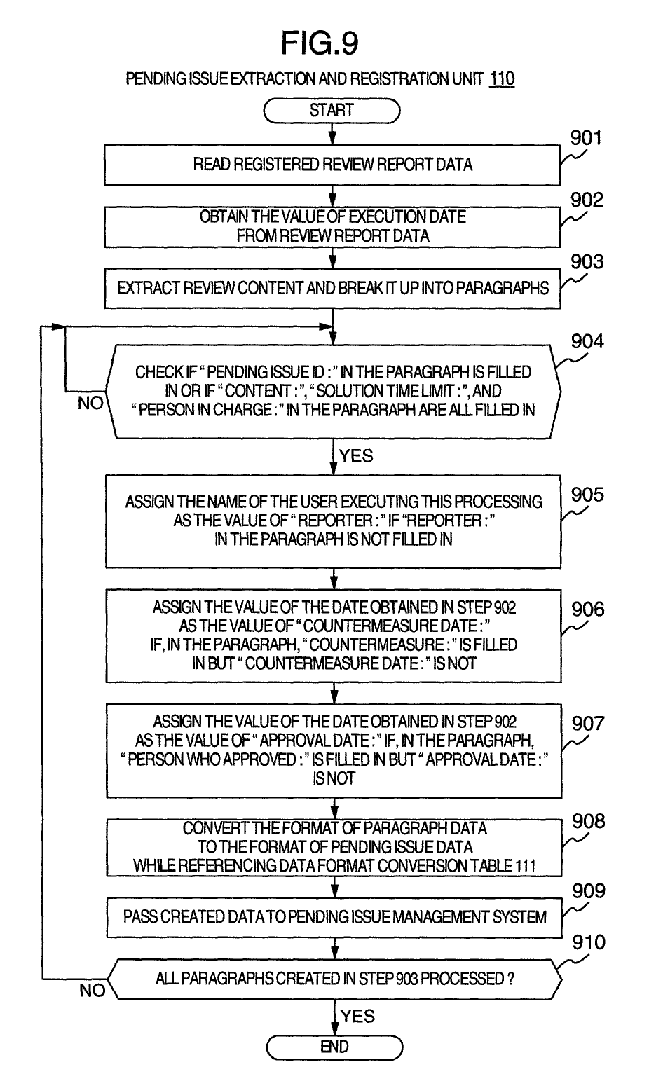

Next, with reference to the flowchart shown in FIG. 9, the following describes, in detail, the processing flow of the pending issue extraction and registration unit 110 that extracts pending issues from the review report data 123 registered with the review report management system 121 and registers the extracted issues with the pending issue management system 141.

First, the pending issue extraction and registration unit 110 reads the registered review report data 123 (step 901) and obtains the value of the date 602 (step 902). In the example in FIG. 6, “2001/8/5” is obtained. Next, the review content 604 is broken up into paragraphs (step 903) while referencing, for example, header numbers such as “1.” in a header character string. In the example in FIG. 6, the review content 604 is broken up into paragraphs 605, 606, and 607.

The pending issue extraction and registration unit 110 executes steps 904-909 for each paragraph created in step 903 and, after processing all paragraphs (determined by conditional branch 910), finishes processing.

Whether or not a paragraph, which is being processed, is to be registered with the pending issue management system 141 is determined by the conditional branch 904. That is, if “Pending issue ID:” in the paragraph is filled in or if “Content:”, “Solution time limit:”, and “Person in charge:” in the paragraph are all filled in, the conditional branch 904 is evaluated as true and processing is performed to register the paragraph with the pending issue management system 141. Otherwise, the paragraph is not registered with the pending issue management system 141 but the conditional branch 904 is executed for the next paragraph not yet processed.

If the conditional branch 904 is true, then the pending issue extraction and registration unit 110 executes processing for adding data that is required for the paragraph to be registered with the pending issue data 142. That is, if “Reporter:” in the paragraph is not filled in, the name of the user executing this processing is assigned as the value of the “Reporter:” (step 905).

If, in the paragraph, the “Countermeasure:” is filled in but “Countermeasure date:” is not, the value of the date obtained in step 902 is assigned as the value of the “Countermeasure date:” (step 906). If, in the paragraph, the “Person who approved:” is filled in but “Approval date:” is not, the value of the date obtained in step 902 is assigned as the value of the “Approval date:” (step 907). That is, if “Countermeasure date:” or “Approval date”:” is not filled in, the date on which the meeting is held (date obtained in step 902) is added in steps 906 or 907 as the value of “Countermeasure date:” or “Approval date”.

Next, the pending issue extraction and registration unit 110 converts the format of paragraph data to the format of pending issue data while referencing the data format conversion table 111 (step 908) and sends the converted data to the pending issue management system 141 (step 909). Finally, a check is made if processing is performed for all paragraphs (step 910).

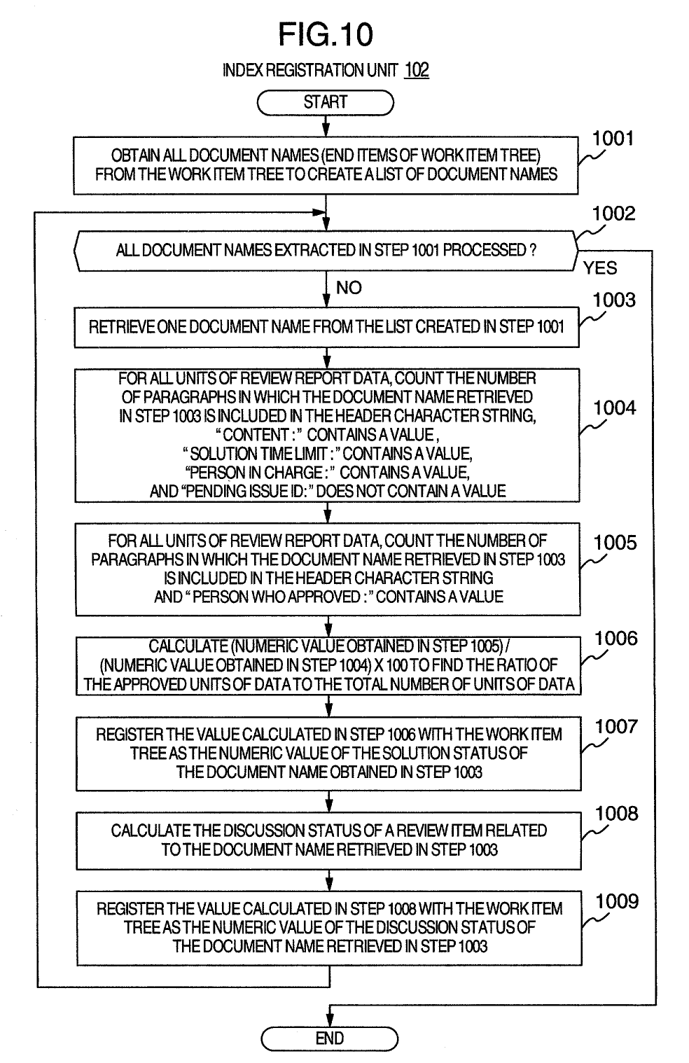

Next, with reference to the flowchart shown in FIG. 10, the following describes the processing flow of the index registration unit 102 in detail. This unit updates the values of the solution status 221-224 and the discussion status 211-214 of the pending issues of the end items (that is, documents 202, 205, 207, and 208), which are included in the work item tree 132 managed by the work item management system 131, to keep those values current. Although the processing of the index registration unit 102 is divided into the steps of two calculators, that is, solution status calculator 103 (steps 1004-1007) and discussion status calculator 104 (steps 1008-1009), the following describes those steps in one flowchart (FIG. 10).

The solution status calculator 103 (steps 1004-1007) analyzes the (plurality of units of) review report data 123 registered with the review report management system 121 and updates the values of the end items in the work item tree 132 managed by the work item management system 131, that is, the solution status 221-224 of the pending issues for the documents 202, 205, 207, and 208.

The discussion status calculator 104 (steps 1008-1009) updates the values of the end items of the work item tree 132 managed by the work item management system 131, that is, the discussion status 211-214 of the documents 202, 205, 207, and 208, based on the discussion status 311-316 included in the review item tree 122 of the review report management system 121 shown in FIG. 3. Assume that the review report management system 121 has a function that updates the values of the discussion status 311-316. This function executes the following processing before the discussion status calculator 104 starts processing; that is, the function checks the header character strings of all paragraphs in the review content part of the registered review data and, for a review item in the review item tree for which there is a matching header character string, changes its discussion status to “◯”.

First, all document names (end items of work item tree 132) are extracted from the work item tree 132 to create a list of document names (step 1001). Steps 1003-1009 are executed for all items (document names) of the list. Whether or not processing should be ended is determined by a conditional branch 1002.

First, one unprocessed document name is retrieved from the list created in step 1001 (step 1003). Then, for all units of review report data, the number of paragraphs is counted in which the retrieved document name is included in the header character string in the review report content part of the review report data 123, “Content:” contains a value, “Solution time limit:” contains a value, “Person in charge:” contains a value, and “Pending issue ID:” does not contain a value (step 1004).

Next, for all units of review report data, the number of paragraphs is counted in which the document name retrieved in step 1003 is included in the header character string and “Person who approved:” contains a value (step 1005).

Next, the ratio of the approved units of data to the total number of units of data is calculated (step 1006), for example, according to the expression (numeric value obtained in step 1005)/(numeric value obtained in step 1004)×100. The value calculated in step 1006 is registered with the work item tree as the numeric value of the solution status of the document name obtained in step 1003 (step 1007).

Next, the discussion status of a review item related to the document name retrieved in step 1003 is calculated (step 1008), and the value calculated in step 1008 is registered with the work item tree 132 as the numeric value of the discussion status of the document name retrieved in step 1003 (step 1009).

The discussion status of a review item is calculated, for example, as ““(the number of “◯”×100+the number of “X”×0)”/Number of child items”, where “◯” is 100% and “X” is 0% for the values of discussion status 311-316 in the review item tree 122. For example, for “ER model” 304 in FIG. 3, “(100+0)/2=50” because this item has child items “Validity of entity” 305 and “Relation with existing entity” 306 and their discussion ratios are “◯” and “X”, respectively.

As described above, when a review report is registered, the system calculates the discussion status and the solution status from the review report data and reflects the status on the work item tree. This allows the user to keep track of the progress status of work items without delay and with no need for human intervention.

It is also possible to store a program, which executes the project information linking method according to the present invention described above, on a storage medium for execution on a computer.

The method according to the present invention allows the user to create the template of a review report, which includes related review items and related pending issues, simply by specifying a document. This template covers all items to be discussed and, at the same time, makes it possible for the user to take measures for all items, that is, pending issues, pointed out at a meeting.

In addition, creating and registering a review report using a created review report template eliminates the need for the user to manually re-enter into the pending issue management system those items pointed out at a meeting and information approved at a meeting.

Another advantage in creating and registering a review report using a created review report template is that the discussion status of review items and the solution status of a document are reflected on the work item management system. This enables the user to find a progress delay in the early stage and to take more efficient countermeasures.

It should be further understood by those skilled in the art that the foregoing description has been made on embodiments of the invention and that various changes and modifications may be made in the invention without departing from the spirit of the invention and the scope of the appended claims.

What is claimed is:

1. A project information linking method for use in a processor connected to a review report management system and a work item management system for communicating information between the systems, said review report management system storing therein a plurality of units of review report data, said work item management system hierarchically defining work items and displaying progress data for said work items, said method comprising the steps of:
reading a document name corresponding to a work name from said work item management system;
obtaining pending issues related to the document name, which was read, from said review report management system; and
outputting a template of a review report in which the obtained pending issues are headers of a review report content.

2. A project information linking method for use in a processor connected to a pending issue management system and a work item management system for communicating information between the systems, said pending issue management system storing therein a plurality of units of pending issue data, said work item management system displaying progress data for hierarchically-defined work items, said method comprising the steps of:
reading a document name corresponding to a work name from said work item management system;
extracting pending issue data on the document name, which was read, from said pending issue management system; and
outputting a template of a review report which contains paragraphs of the extracted pending issue data, each paragraph corresponding to one pending issue.

3. A project information linking method for use in a processor connected to a review report management system, a pending issue management system, and a work item management system for communicating information between the systems, said review report management system storing therein a plurality of units of review report data, said pending issue management system storing therein a plurality of units of pending issue data, said work item management system displaying progress data for hierarchically-defined work items, said method comprising the steps of:
reading a document name corresponding to a work name from said work item management system;
obtaining pending issues related to the document name, which was read, from said review report management system;
outputting a template of a review report in which the obtained pending issues are headers of a review report content;
extracting pending issue data on the document name, which was read, from said pending issue management system; and
adding the extracted pending issue data to the template of a review report which was output, each pending issue corresponding to one paragraph.

4. The project information linking method according to claim 1, further comprising the steps of:
extracting pending issues from review report data created based on the template of a review report that was output;
converting the extracted pending issues to a data format that may be registered with said pending issue management system; and
registering the converted data with said pending issue management system.

5. A project information linking method for use in a processor connected to a review report management system and a work item management system for communicating information between the systems, said review report management system storing therein a plurality of units of review report data, said work item management system displaying progress data for hierarchically-defined work items, said method comprising the steps of:
calculating a countermeasure ratio of a pending issue from the review report data; and
registering the countermeasure ratio with said work item management system.

6. A project information linking method for use in a processor connected to a review report management system and a work item management system for communicating information between the systems, said review report management system storing therein a plurality of units of review report data, said work item management system displaying progress data for hierarchically-defined work items, said method comprising the steps of:
calculating a discussion ratio of a review item from the review report data; and
registering the discussion ratio with said work item management system.

7. A project information linking system connected to a review report management system and a work item management system for communicating information between the systems, said review report management system storing therein a plurality of units of review report data, said work item management system displaying progress data for hierarchically-defined work items, said system comprising:
means for storing relation definition data for relating at least one of a work item name and a document name stored in said work item management system to a pending issue stored in said review report management system; and
review report template creating means for obtaining a document name corresponding to a work name from said work item management system, for obtaining pending issues related to the document name from said review report management system based on the relation definition data, and for outputting a template of a review report that contains the obtained pending issues as headings of review contents.

8. A project information linking system connected to a pending issue management system and a work item management system for communicating information between the systems, said pending issue management system storing therein a plurality of units of pending issue data, said work item management system hierarchically defining work items and displaying progress data for the work items, said system comprising:
means for storing a data format conversion table that converts pending issue data stored in said pending issue management system to review report data; and
review report template creating means for reading a document name corresponding to a work name from said work item management system, for extracting pending issue data related to the document name from said pending issue management system, and for outputting a review report template for each of the plurality of extracted pending issues according to said data format conversion table.

9. A project information linking system connected to a review report management system, pending issue management system, and a work item management system for communicating information between the systems, said review report management system storing therein a plurality of units of review report data, said pending issue management system storing therein a plurality of units of pending issue data, said work item management system displaying progress data for hierarchically-defined work items, said system comprising:
means for storing relation definition data, which relates document names corresponding to work names stored in said work item management system to pending issues stored in said review report management system, and a data format conversion table which converts pending issue data stored in said pending issue management system to review report data;
means for reading a document name corresponding to a work name from said work item management system, for obtaining pending issues related to the document name from said pending issue management system; and for forming a review content part which contains paragraphs of the extracted pending issues, each paragraph corresponding to one pending issue; and
review report template creating means for extracting pending issue data related to the document name from pending issue management system, for forming the plurality of extracted pending issues into paragraphs according to the data format conversion table, one paragraph for each issue, for adding the paragraphs to the review content part, and for outputting the review report template.

10. A project information linking system according to claim 7, further comprising:
pending issue extracting and registering means for extracting pending issues from the review report data created based on the review report template output by said review report template creating means, for converting the pending issues to a format that may be registered with said pending issue management system, and for registering the converted pending issues with said pending issue management system.

11. A project information linking system connected to a review report management system and a work item management system for communicating information between the systems, said review report management system storing therein a plurality of units of review report data, said work item management system displaying progress data for hierarchically-defined work items, said method system comprising:
index registering means for calculating a countermeasure ratio of a pending issue from review report data stored in said review report management system and for registering the countermeasure ratio with said work item management system.

12. A project information linking system connected to a review report management system and a work item management system for communicating information between the systems, said review report management system storing therein a plurality of units of review report data, said work item management system displaying progress data for hierarchically-defined work items, said system comprising:
index registering means for calculating a discussion ratio of a review item from review report data stored in said review report management system and for registering the discussion ratio with said work item management system.

13. A recording medium storing therein a program executing a project information linking method for use in a processor connected to a review report management system and a work item management system for communicating information between the systems, said review report management system storing therein a plurality of units of review report data, said work item management system hierarchically defining work items and displaying progress data for said work items, said method comprising the steps of:
reading a document name corresponding to a work name from said work item management system;
obtaining pending issues related to the document name, which was read, from said review report management system; and
outputting a template of a review report in which the obtained pending issues are headers of a review report content.
